(19) United States
(12) Patent Application Publication
(10) Pub. No.: US 2026/0221028 A1
(43) Pub. Date: Jul. 30, 2026

(54) EMERGENCY ALERT SYSTEM FOR TRAFFIC INTERSECTIONS AND METHOD THEREFOR

(71) Applicant: Christopher Ball, Yakima, WA (US)

(72) Inventor: Christopher Ball, Yakima, WA (US)

(21) Appl. No.: 19/041,692

(22) Filed: Jan. 30, 2025

(51) Int. Cl. G08G 1/09; G08G 1/017

(52) U.S. Cl. CPC G08G 1/09; G08G 1/0175

(57) ABSTRACT

An emergency alert system for traffic intersections includes an emergency alert device and a transmitter unit. The emergency alert device is connectable to a traffic light system to supply power to the emergency alert device. The emergency alert device includes a camera, a speaker, and a light unit. The speaker emits sounds and the light unit emits light. The camera is used to obtain images of license plates of vehicles when the vehicles drive in an unauthorized manner through the traffic intersection, which images are wirelessly transmitted to a camera data storage. A transmitter unit is mountable in an emergency vehicle. The transmitter unit includes an interface that is selectively manually activatable to activate the transmitter unit to send a signal to the wireless transceiver of the emergency alert device to activate the emergency alert device.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to emergency lights and sound systems and more particularly pertains to a new emergency alert system for alerting pedestrians and drivers at a traffic intersection that an emergency vehicle, such as a fire truck, police car, or ambulance, is approaching the intersection.

### (2) Description of Related Art Including Information Disclosed Under 37 CFR 1.97 and 1.98

The prior art relates to emergency lights and sound systems for traffic intersections that can provide audio and visual alerts when an emergency vehicle is traveling through the intersection. The prior art, as best understood, does not disclose emergency alert system that includes an emergency alert device suspendable from a mast arm pole of a traffic light system, which emergency alert device includes a camera designed to obtain images of license plates of vehicles when said vehicles drive in an unauthorized manner through the traffic intersection. The prior art also does not disclose a transmitter unit that is mountable in an emergency vehicle, wherein the transmitter unit includes an interface being selectively manually activatable to activate the transmitter unit to send a signal to the emergency alert device to activate the emergency alert device

### (h) BRIEF SUMMARY OF THE INVENTION

An embodiment of the disclosure meets the needs presented above in a emergency alert system generally comprising an emergency alert device and a transmitter unit. The emergency alert device is connectable to a traffic light system to supply power to the emergency alert device. The emergency alert device includes a housing. A mounting bracket is coupled to the housing. The mounting bracket is designed to be coupled to a mast arm pole of the traffic light system to suspend the housing from the mast arm pole. A camera is mounted in the housing. The camera is designed to obtain images of license plates of vehicles when the vehicles drive in an unauthorized manner through the traffic intersection. A wireless transceiver is positioned in the housing. The wireless transceiver is connected to the camera to transmit the images to a camera data storage. A speaker is mounted in the housing. The speaker is designed to emit sounds. A light unit is mounted in the housing. The light unit is designed to emit light in multiple directions. A microprocessor is positioned in the housing. The microprocessor is connected to and designed to control operation of each of the camera, the wireless transceiver, the speaker, and the light unit. A transmitter unit is mountable in an emergency vehicle. The transmitter unit includes an interface is selectively manually activatable to activate the transmitter unit to send a signal to the wireless transceiver of the emergency alert device to activate the emergency alert device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an emergency alert device according to an embodiment of the disclosure.

FIG. 2 is a front view of the emergency alert device according to an embodiment of the disclosure in use.

FIG. 3 is a perspective view of a transmitter unit according to an embodiment of the disclosure in use.

FIG. 4 is a block diagram of view of an emergency alert system according to an embodiment of the disclosure.

FIG. 5 is a front view of an alternative embodiment of the emergency alert device.

FIG. 6 is a schematic view of the transmitter unit according to an embodiment of the disclosure.

### (j) DETAILED DESCRIPTION OF THE INVENTION

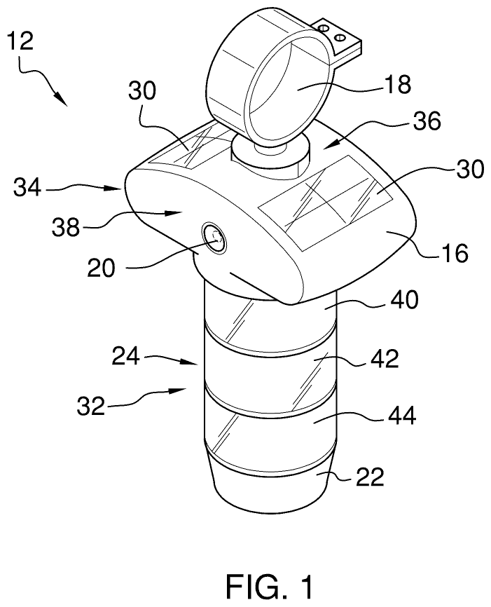

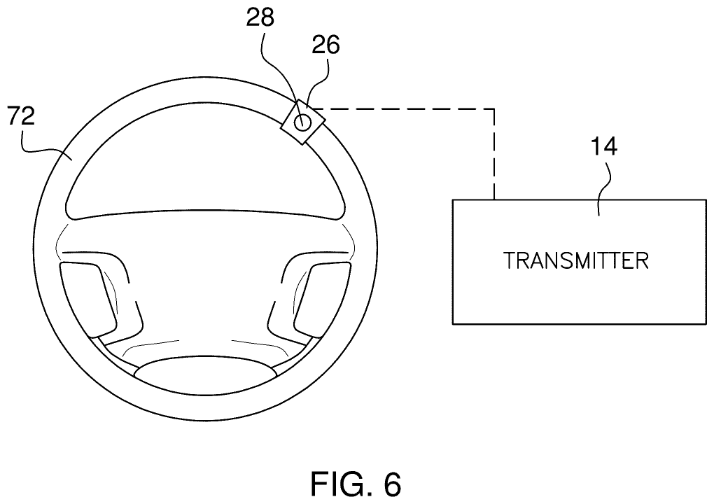

With reference now to the drawings, and in particular to FIGS. 1 through 6 thereof, a new emergency alert system embodying the principles and concepts of an embodiment of the disclosure and generally designated by the reference numeral 10 will be described.

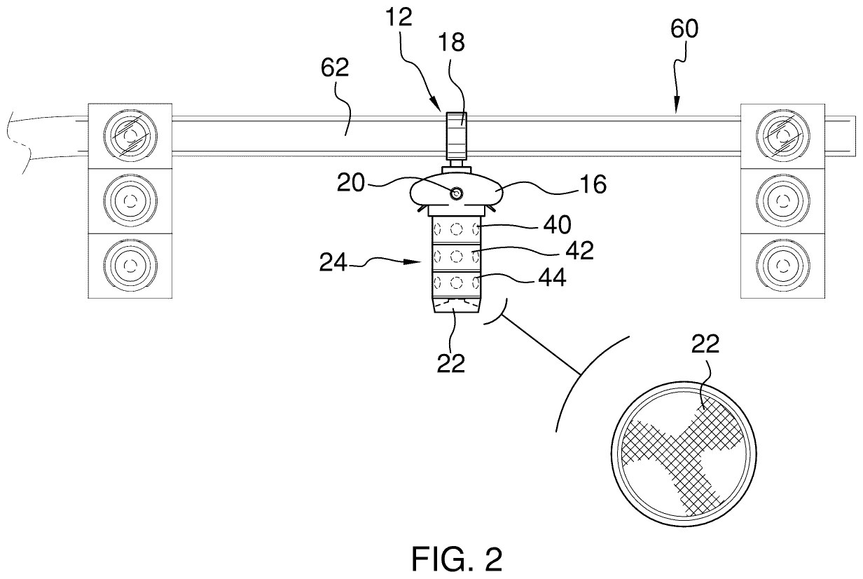

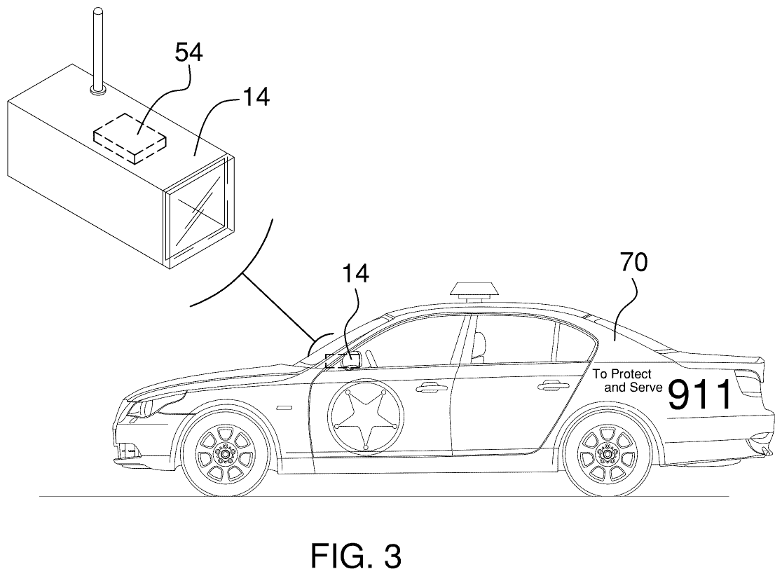

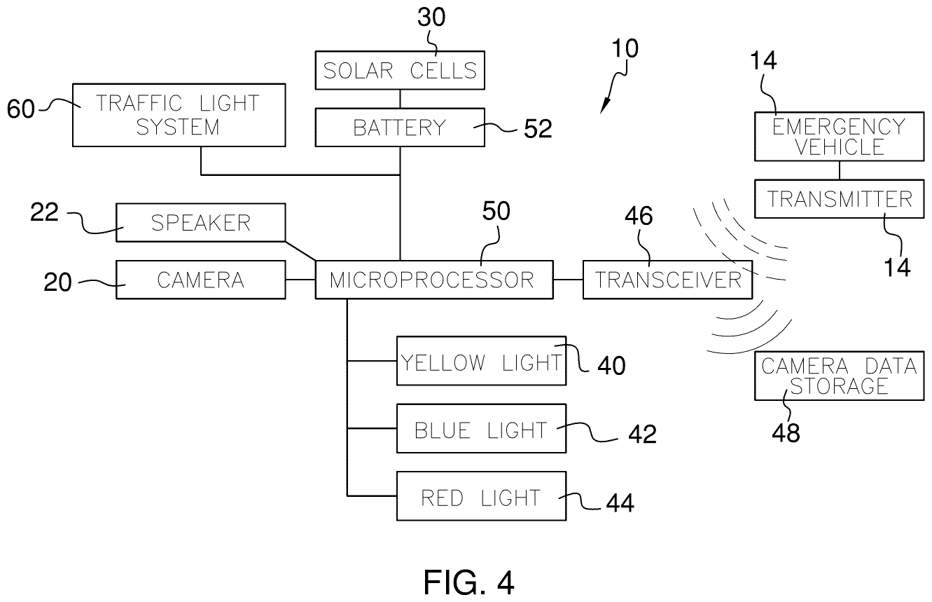

As best illustrated in FIGS. 1 through 6, the emergency alert system 10 for traffic intersections, shown in a box diagram in FIG. 4, generally includes an emergency alert device 12, shown in FIGS. 1 and 2, and a transmitter unit 14, shown in FIG. 3. The emergency alert device 12 is connectable to a traffic light system 60 to supply power to the emergency alert device 12. For convenience, the electrical connections are not shown, but could be accomplished in a known manner by wiring. The emergency alert device 12 includes a housing 16. A mounting bracket 18 is coupled to the housing 16. As shown in FIG. 1, the mounting bracket 18 is designed to be coupled to a mast arm pole 62 of the traffic light system 60 to suspend the housing 16 from the mast arm pole 62. The mounting bracket 18 is a C-shaped clip, but other designs are well within the scope of the disclosure. A camera 20 is mounted in the housing 16. The camera 20 is designed to obtain images of license plates of vehicles when the vehicles drive in an unauthorized manner through the traffic intersection. A wireless transceiver 46, shown in the box diagram in FIG. 4, is positioned in the housing 16. The wireless transceiver 46 is connected to the camera 20 to transmit the images to a camera data storage 48, such as computer database at a law enforcement agency. As shown in FIG. 2, a speaker 22 is mounted in the housing 16. The speaker 22 is designed to emit sounds. A light unit 24 is mounted in the housing 16. The light unit 24 is designed to emit light in multiple directions. A microprocessor 50, shown in the box diagram in FIG. 4, is positioned in the housing 16. The microprocessor 50 is connected to and designed to control operation of each of the camera 20, the wireless transceiver 46, the speaker 22, and the light unit 24. The transmitter unit 14 is mountable in an emergency vehicle 70 as shown in FIG. 3. The transmitter unit 14 includes an interface 26 that is selectively manually activatable to activate the transmitter unit 14 to send a signal to the wireless transceiver 46 of the emergency alert device 12 to activate the emergency alert device 12.

The interface 26 is a button 28 mountable on a surface of a component of the emergency vehicle 70. The button 28 is pressable to selectively activate the transmitter unit 14. In the exemplary embodiment in FIG. 4, the button 28 is mountable on a steering wheel 72 of the emergency vehicle 70. This allows a driver of the emergency vehicle 70 to easily activate the transmitter unit 14 while driving. The interface 26 could be connected to the transmitter 54 of the transmitter unit 12 by wiring or wirelessly. In another possible embodiment, the interface 26

The emergency alert system 10 further includes a battery 52 and solar cells 30. The battery 52, shown in the box diagram in FIG. 4, is positioned in the housing 16. The battery 52 is designed to supply backup power to each of the microprocessor 50, the camera 20, the wireless transceiver 46, the speaker 22, and the light unit 24 when there is a power failure to the traffic light system 60. The solar cells 30 are positioned in the housing 16. The solar cells 30 are connected to the battery 52 to charge the battery 52. In one possible embodiment, the emergency alert device 12 is not connected to the traffic light system 60, but rather is powered solely by the battery 52 and the solar cells 30.

FIGS. 1 and 2 show an exemplary embodiment of the emergency alert device 12. The housing 16 is T-shaped and includes a body portion 32 and a head portion 34 projecting out beyond the body portion 32 in two opposing directions. The mounting bracket 18 is positioned to project out of a top surface 36 of the head portion 34. The solar cells 30 are positioned on the top surface 36 of the head portion 34 of the housing 16. The camera 20 is positioned in a side surface 38 of the head portion 34 of the housing 16. The light unit 24 is positioned in the body portion 32 of the housing 16. The speaker 22 is positioned under the light unit 24 in the body portion 32 of the housing 16.

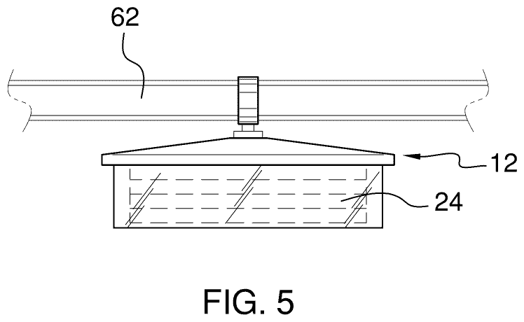

Various types of lights can be utilized for the emergency alert device 12, and thus different embodiments of the light unit 24 are within the scope of the disclosure as are well known in the lighting arts and should not be understood as being limited by the exemplary embodiments in the drawings. The light unit 24 can be designed to emit light over a 360-degree range. The light unit 24 can be designed to emit different colors of light. The light unit 24 can be designed to emit light with a strobe effect. In the exemplary embodiment in FIGS. 1 and 2, the light unit 24 includes a yellow light 40, a blue light 42, and a red light 44 positioned in a vertical stack with the yellow light 40 on top of the blue light 42 and the blue light 42 on top of the red light 44. FIG. 5 shows an alternative embodiment in which the housing 16 is box-shaped and the light unit 24 is a light emitting diode arrangement designed to emit different colors of light in accordance with programming. For convenience, only the light unit 24 is shown in detail in FIG. 5, and it should be understood that the other components of the emergency alert device 12 could be included in this design.

The emergency alert system 10 is used to provide an emergency alert at a traffic intersection. A driver or passenger of the emergency vehicle 70 can manually activate the transmitter unit 14, such as by pressing the button 28, in the emergency vehicle 70 when the emergency vehicle 70 is approaching the traffic intersection. The transmitter unit 14 sends a signal to the emergency alert device 12 and activates the camera 20, the speaker 22, and the light unit 24. Light of different types as desired or programmed is then emitted by the light unit 24. For example, the yellow light 40 could be activated as a warning, whereas the blue light 42 and the red light 44 could be activated alternatively in a solid light or in a flashing manner to indicate the emergency vehicle 70 is present and drivers should stop. Sounds, such as alarms or messages, as desired or programmed are then emitted by the speaker 22. The camera 20 obtains images of license plates of vehicles when the vehicles drive in an unauthorized manner through the traffic intersection, such as driving when the red light 44 and the blue light 42 are flashing to indicate that drivers should stop. The images are then wirelessly transmitted to the camera data storage 48. In this manner, law enforcement can prosecute persons who disregard the emergency warnings and thereby increase safety through deterrence.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An emergency alert system for traffic intersections comprising:
an emergency alert device being connectable to a traffic light system to supply power to said emergency alert device, said emergency alert device comprising:
a housing;
a mounting bracket being coupled to said housing, said mounting bracket being configured to be coupled to a mast arm pole of the traffic light system to suspend said housing from the mast arm pole;
a camera being mounted in said housing, said camera being configured to obtain images of license plates of vehicles;
a wireless transceiver being positioned in said housing, said wireless transceiver being connected to said camera to transmit the images to a camera data storage;
a speaker being mounted in said housing, said speaker being configured to emit sounds;
a light unit being mounted in said housing, said light unit being configured to emit light in multiple directions;
a microprocessor being positioned in said housing, said microprocessor being connected to and configured to control operation of each of said camera, said wireless transceiver, said speaker, and said light unit; and
a transmitter unit being mountable in an emergency vehicle, said transmitter unit includes an interface being selectively manually activatable to activate said transmitter unit to send a signal to said wireless transceiver of said emergency alert device to activate said emergency alert device.

2. The emergency alert system of claim 1, wherein:
said interface is a button mountable on a surface of a component of the emergency vehicle; and
said button is pressable to selectively activate said transmitter unit.

3. The emergency alert system of claim 2, wherein said button is mountable on a steering wheel of the emergency vehicle.

4. The emergency alert system of claim 1, further including:
a battery being positioned in said housing, said battery being configured to supply backup power to each of said microprocessor, said camera, said wireless transceiver, said speaker, and said light unit when there is a power failure to the traffic light system; and
solar cells being positioned in said housing, said solar cells being connected to said battery to charge said battery.

5. The emergency alert system of claim 4, wherein:
said housing is T-shaped and includes a body portion and a head portion projecting out beyond said body portion in two opposing directions; and
said mounting bracket is positioned to project out of a top surface of said head portion.

6. The emergency alert system of claim 5, wherein said camera is positioned in a side surface of said head portion of said housing.

7. The emergency alert system of claim 5, wherein said light unit is positioned in said body portion of said housing.

8. The emergency alert system of claim 5, wherein said speaker is positioned under said light unit in said body portion of said housing.

9. The emergency alert system of claim 5, wherein said solar cells are positioned on said top surface of said head portion of said housing.

10. The emergency alert system of claim 1, wherein said light unit is configured to emit light over a 360-degree range.

11. The emergency alert system of claim 1, wherein said light unit is configured to emit different colors of light.

12. The emergency alert system of claim 1, wherein said light unit is configured to emit light with a strobe effect.

13. The emergency alert system of claim 1, wherein said light unit includes a light emitting diode arrangement configured to emit different colors of light.

14. The emergency alert system of claim 1, wherein said light unit includes a yellow light, a blue light, and a red light positioned in a vertical stack with said yellow light on top of said blue light and said blue light on top of said red light.

15. The emergency alert system of claim 3, further including:
a battery being positioned in said housing, said battery being configured to supply backup power to each of said microprocessor, said camera, said wireless transceiver, said speaker, and said light unit when there is a power failure to the traffic light system; and
solar cells being positioned in said housing, said solar cells being connected to said battery to charge said battery.

16. The emergency alert system of claim 15, wherein:
said housing is T-shaped and includes a body portion and a head portion projecting out beyond said body portion in two opposing directions;
said mounting bracket is positioned to project out of a top surface of said head portion;
said solar cells are positioned on said top surface of said head portion of said housing;
said camera is positioned in a side surface of said head portion of said housing;
said light unit is positioned in said body portion of said housing; and
said speaker is positioned under said light unit in said body portion of said housing.

17. The emergency alert system of claim 16, wherein:
said light unit is configured to emit light over a 360-degree range;
said light unit is configured to emit different colors of light; and
said light unit is configured to emit light with a strobe effect.

18. The emergency alert system of claim 17, wherein said light unit includes a light emitting diode arrangement configured to emit different colors of light.

19. The emergency alert system of claim 17, wherein said light unit includes a yellow light, a blue light, and a red light positioned in a vertical stack with said yellow light on top of said blue light and said blue light on top of said red light.

20. A method of providing an emergency alert at a traffic intersection, said method comprising the steps of:
providing an emergency alert system comprising:
an emergency alert device being connectable to a traffic light system to supply power to said emergency alert device, said emergency alert device comprising:
a housing;
a mounting bracket being coupled to said housing, said mounting bracket being configured to be coupled to a mast arm pole of the traffic light system to suspend said housing from the mast arm pole;
a camera being mounted in said housing, said camera being configured to obtain images of license plates of vehicles;
a wireless transceiver being positioned in said housing, said wireless transceiver being connected to said camera to transmit the images to a camera data storage;
a speaker being mounted in said housing, said speaker being configured to emit sounds;
a light unit being mounted in said housing, said light unit being configured to emit light in multiple directions;
a microprocessor being positioned in said housing, said microprocessor being connected to and configured to control operation of each of said camera, said wireless transceiver, said speaker, and said light unit; and
a transmitter unit being mountable in an emergency vehicle, said transmitter unit includes an interface being selectively manually activatable to activate said transmitter unit to send a signal to said wireless transceiver of said emergency alert device to activate said emergency alert device;
manually activating said transmitter unit in the emergency vehicle when the emergency vehicle is approaching the traffic intersection;
sending a signal to said emergency alert device and activating said camera, said speaker, and said light unit;
emitting light with said light unit;
emitting sound with said speaker;
obtain images of license plates of vehicles when said vehicles drive in an unauthorized manner through the traffic intersection; and
wirelessly transmitting the images to a camera data storage.
